(19) United States
(12) Patent Application Publication
(10) Pub. No.: US 2005/0011691 A1
(43) Pub. Date: Jan. 20, 2005

(54) Reverse Hybrid Automobile

(75) Inventor: Keith Adams, Spokane Valley, WA (US)

Correspondence Address: Keith Adams, 12008 E. 24thAve., Spokane Valley, WA, 99206, US

(73) Assignee: Keith Adams, Spokane Valley, WA (US)

(21) Appl. No.: 10/604,421

(22) Filed: Jul. 18, 2003

(51) Int. Cl. B60K 1/00

(52) U.S. Cl. 180/65.3

(57) ABSTRACT

An automobile that consist of a chassis constructed of lightweight steel tubing and the body consist of fiberglass/plastic composite. The vehicle should weigh between 2,000 and 2,500 lbs. This vehicle is propelled by two DC electric motors that are derive their power from an electric generating unit that runs on unleaded gasoline, propane, natural gas or an alcohol based fuel. This car can get over 100 miles per gallon, carry five passengers and have a max speed of 80 mph. This vehicle will have the same appearance and size as standard sedans that are gas powered.

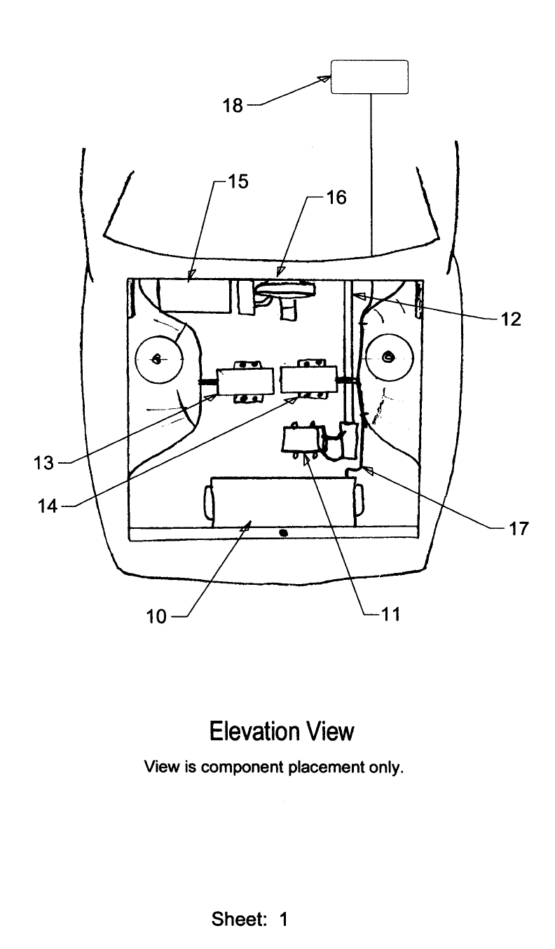

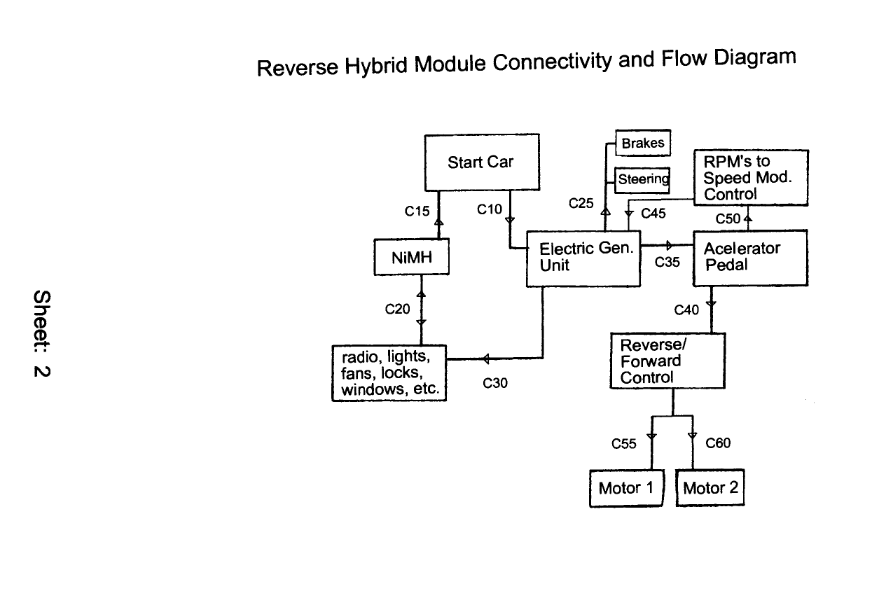

### BACKGROUND OF INVENTION

Currently the concept of an alternative vehicle for automotive use has been an all-electric car or a gasoline-electric hybrid. The drawback of the electric car is that it has a standard chassis and consists of over 1,000 lbs. of batteries. The passenger capacity is reduced to two people. The speed and distance are limited. Trunk capacity is nonexistent. An all-electric automobile needs higher maintenance of the 1,000-pound battery array. Overall vehicle weight can exceed 4,000 pounds.

The gasoline-electric hybrid is a good start but still uses the current frame and body technology along with a gasoline powered motor as a main drive and an electric motor as reserve power when needed for acceleration.

Washington State alone is gravitating towards vehicles with lower gas mileage. Individuals are purchasing SUV's and Sedans to enjoy the feeling of a full-size ride. WE cannot legislate people to buy small fuel-efficient cars. They need to see that will fit “their” needs.

Hydrogen Fuel Cell technology is also raising concerns of safety and ecology. In accidents, hydrogen gases that are released have a more deadly effect than standard gasoline. Also, studies have found that during storage or transportation, 10% of the gas is lost, which combines in the atmosphere. This venting will cause the ozone hole to remain open longer and perpetuate the greenhouse effect.

### BRIEF DESCRIPTION OF DRAWINGS

Sheet 1 shows an elevation view of the Reverse Hybrid Car. This is a basic component layout. This view show the Electric Generating Unit (10), Power Steering Pressure generating Pump (11), Steering Column (12), DC Electric Motor 1 (13), DC Electric Motor 2 (14), Nickel Metal Hydride Battery (15), Power Brake Assist Unit (16), Fuel Line (17) and Fuel Tank (18).

The framework and chassis are not shown so that it is easier to view the important components that make up the Reverse Hybrid Car.

Sheet 2 is a Flow Diagram that represents the connectivity between the components that make up the Reverse Hybrid Car. Explanation of connections are as follows. When starting the Reverse Hybrid Car, C10 sends electricity to the ignition switch, that when engaged, turns the starter on the Electric Generation Unit (10) which takes over the provision of supplying electricity to various components along C30, also recharging the NiMH Battery (15) back along C20. The Steering Pump (11) and Power Brake Assist Unit (16) are then powered along C25.

Once the Reverse Hybrid Car is running, power from the Electric Generation Unit (10) is sent to the Accelerator Pedal thru C35, then thru C40 to the Reverse/Forward Control. The driver will select to go in Reverse or Forward movement. When the Accelerator Pedal is depressed, the RPM to Speed Module along connection C50 will tell the Electric Generation Unit (10) thru connection C45, to idle up to provide the necessary wattage to achieve the speed required by the driver. Power flows from C40 to the Reverse/Forward Control then thru C55 and C60 powering Motor 1 and 2.

### DETAILED DESCRIPTION

An onboard generator will produce the required watts needed to power the twin DC electric motors. This electric generating unit will be constructed as a modular device that can easily be serviced and replaced by simply unlatching the unit and latching in a replacement unit in just a few minutes.

The fuel to power the electric generating unit will be in a quick-detach container that is designed in a modular style, that allows for easy service and replacement.

A small NiMH (Nickel Metal Hydride) battery will exist as only to power onboard electronics, heating and cooling environmental systems, prior to starting the electric generating unit. The NiMH is recharged after the electric unit is started and takes over the running of the electronics, heating and cooling environmental systems.

The Reverse Hybrid body will be constructed of a fiberglass or durable plastic composite. A durable tube-steel sub-frame will provide passenger protection and give the body a framework for body panel mounting. The sub-frame design will reflect current NASCAR standards for protecting drivers as well as occupants. Current airbag and restraint technologies will also be added.

The Reverse Hybrid chassis will be fabricated from tube-steel for lightness and the mounting of all other parts such as body, wiring, steering and mounting of two DC electric motors. The motors will be mounted in a fashion that allows the motors to be easily removed and serviced.

The dashboard will indicate fuel level, speed, wattage out-put and miles traveled. Braking is achieved thru a power-assist unit to aid in stopping the car with a standard disc brake unit on each wheel. Steering will be also using a power-assist unit to aid in control of steering the car.

This Patent is to also cover the addition of two other electric motors. These would be added for larger uses such as load hauling or in a truck design using the similar method of powering the additional DC motors.

Speed control of the Reverse Hybrid Car is accomplished by pressing up or down on the accelerator pedal. This pedal is tied to the Electric Generating Unit and controls the idle of the unit. Hence, the farther you depress the accelerator pedal, the faster the RPM's of the Electric Generating Unit and the greater amount of electricity produced, which turns the DC motors faster, resulting in the acceleration of the vehicle.

All the Reverse Hybrid Car's electric generating, drive motors, steering control and braking will be located at the front of the car under the hood. This configuration frees up trunk space and rear passenger seating. Fuel is stored in a 5-gallon tank under the rear of the car and transferred to the Electric Generating Unit via a fuel line. Spent gases will be vented to the rear of the car.

1. The reverse hybrid automobile will get over 100 miles per gallon, will have a maximum speed of 80 mile per hour, a range of 500 miles on a 5 gallon tank of fuel and have components that can be changed out during repairs in 10 minutes or less:

2. Quick component change will allow Reverse Hybrid Automobile owners to swap units out quickly for repairs or replacement. The Electric Generating Unit will connect to the automobile through a series of quick-connects mounted at the base of the unit and fastened down with a latching system.
